(19) United States
(12) Patent Application Publication
(10) Pub. No.: US 2024/0034488 A1
(43) Pub. Date: Feb. 1, 2024

(54) UNMANNED AERIAL VEHICLE AND SELF-DESTRUCT DRONE OPERATING SYSTEM INCLUDING SAME

(71) Applicant: DARTS. Co., Ltd., Daejeon (KR)

(72) Inventors: Se Young KIM, Chungcheongbuk-do (KR); Min Gyu CHEON, Seoul (KR); Jin Hwan JEONG, Gyeonggi-do (KR); Dae Won HONG, Gyeonggi-do (KR)

(73) Assignee: DARTS. Co., Ltd., Daejeon (KR)

(21) Appl. No.: 18/020,952

(22) PCT Filed: Aug. 19, 2020
(86) PCT No.: PCT/KR2020/011018

§ 371 Date: Feb. 13, 2023

(30) Foreign Application Priority Data
Aug. 13, 2020 (KR) 10-2020-0101622

(51) Int. Cl. B64U 10/14; B64U 30/20; F41G 3/06; G01S 19/18

(52) U.S. Cl. CPC B64U 10/14; B64U 30/20; F41G 3/065; G01S 19/18; B64U 2101/15

(57) ABSTRACT

The present invention relates to an unmanned aerial vehicle and a self-destruct drone operating system including the same, and according to an unmanned aerial vehicle related to one example of the present invention and a self-destruct drone operating system including the same, it can overcome gravity, descend vertically to a target at a high speed, and be precisely guided, by rotating a propeller of a rotor in the reverse direction.

### TECHNICAL FIELD

The present invention relates to an unmanned aerial vehicle and a self-destruct drone operating system including the same.

This application claims the benefit of priority based on Korean Patent Application No. 10-2020-0101622 dated Aug. 13, 2020, the disclosure of which is incorporated herein by reference in its entirety.

### BACKGROUND ART

In main attack targets, such as tactical vehicles or armored vehicles, by self-destruct drones, the upper part is relatively more vulnerable to attacks than the side part, so that many missiles and self-destruct drones are developed for upper attacks, but because it is difficult for multicopter or helicopter-type drones to fly down at high speeds, they are difficult to attack the upper part of the enemy at high speeds. Therefore, there are restrictions in using self-destruct drones, so that there is a limit to uses of self-destruct drones.

Meanwhile, in order to transmit the location of the target to the self-destruct drone, the target search and accurate estimation of the location are required.

Recently, as operations using drones have increased in the military, the demand for accurate global coordinate acquisition of targets for operating drones has increased. However, in relation to existing targeting equipment for missiles, a method of continuously designating positions using a laser target designator, or a method of searching for a target using a TADS (Target Acquisition & Designation System), and then estimating its relative position with the target was all.

### DISCLOSURE

### Technical Problem

It is an object to be solved by the present invention to provide a target location estimation device capable of estimating a position of a target by measuring an azimuth angle and an elevation angle using a moving baseline of a GPS system using two GPS antennas, and measuring the distance to the target using a laser range finder (LRF), and a self-destruct drone operating system including the same.

Also, it is an object to be solved by the present invention to provide an unmanned aerial vehicle capable of performing a high-speed descending attack that conventional rotary wings could not do by controlling an airframe in the direction of gravitational force, and a self-destruct drone operating system including the same.

In addition, it is an object to be solved by the present invention to provide a self-destruct drone operating system capable of estimating location information of a target, transmitting the location information and mission start command to an unmanned aerial vehicle, and performing a strike guidance flight with the unmanned aerial vehicle.

### Technical Solution

In order to solve the above-described objects, according to one aspect of the present invention, an unmanned aerial vehicle comprising a plurality of rotors capable of rotating in forward and reverse directions, and a flight control part provided to control the rotors, and to receive an operation command from an external device, wherein each rotor comprises a plurality of blades, the airfoil of which has a bilaterally symmetrical shape, is provided.

In addition, according to another aspect of the present invention, a self-destruct drone operating system comprising the unmanned aerial vehicle, and a target observation-and-location estimation device for transmitting target location information and operation commands to the unmanned aerial vehicle is provided.

Here, the unmanned aerial vehicle comprises a plurality of rotors capable of rotating in forward and reverse directions, and a flight control part provided to control the rotors, and to receive an operation command from an external device, wherein each rotor comprises a plurality of blades, the airfoil of which has a bilaterally symmetrical shape. Also, the target observation-and-location estimation device comprises a range finder for measuring the distance (D) to the target, a GPS module provided to measure north-based azimuth angle (Ψ) and elevation angle (θ) of the target, an observation control part provided to calculate location information of the target including the latitude, longitude and altitude of the target, based on the north-based azimuth angle (Ψ) and elevation angle (θ) of the target measured in the GPS module, and to transmit the distance to the target and the location information of the target to the unmanned aerial vehicle, and a display part provided to display image information and location information of the target. In addition, the GPS module comprises a first GPS antenna and a second GPS antenna positioned apart from the first GPS antenna by a predetermined distance (d), and the GPS module is provided to measure north-based azimuth angle (Ψ) and elevation angle (θ) based on the relative positions of the first and second GPS antennas.

Furthermore, according to another aspect of the present invention, a target observation-and-location estimation device comprising a range finder for measuring the distance (D) to the target, a GPS module provided to measure north-based azimuth angle (Ψ) and elevation angle (θ) of the target, an observation control part provided to calculate location information of the target including the latitude, longitude and altitude of the target, based on the north-based azimuth angle (Ψ) and elevation angle (θ) of the target measured in the GPS module, and to transmit the distance to the target and the location information of the target to an external device, and a display part provided to display image information and location information of the target is provided.

Also, the GPS module comprises a first GPS antenna and a second GPS antenna positioned apart from the first GPS antenna by a predetermined distance (d).

In addition, the GPS module is provided to measure north-based azimuth angle (Ψ) and elevation angle (θ) based on the relative positions of the first and second GPS antennas.

Furthermore, according to another aspect of the present invention, a firearm equipped with the target observation-and-location estimation device is provided.

Also, according to another aspect of the present invention, it is a control method of the target observation-and-location estimation device, and thus a method of controlling the target observation-and-location estimation device, comprising steps of measuring the position of the target with the first GPS antenna, measuring the position of the target with the second GPS antenna, and calculating location information of the target including the latitude, longitude and altitude of the target, based on the north-based azimuth angle (Ψ) and elevation angle (θ) of the target measured using the respective positions of the first GPS antenna and the second GPS antenna, and the distance (D) to the target measured by the range finder, is provided.

In addition, according to another aspect of the present invention, a self-destruct drone operating system comprising an unmanned aerial vehicle, and the target observation-and-location estimation device provided to provide location information of the target to the unmanned aerial vehicle is provided. Here, the target observation-and-location estimation device comprises a range finder for measuring the distance (D) to the target, a GPS module provided to measure the north-based azimuth angle (Ψ) and elevation angle (θ) of the target, a flight control part provided to calculate location information of the target including the latitude, longitude and altitude of the target, based on the north-based azimuth angle (Ψ) and elevation angle (θ) of the target measured in the GPS module, and to transmit the distance to the target and the location information to the unmanned aerial vehicle, and a display part provided to display image information and location information of the target. Furthermore, the GPS module comprises a first GPS antenna and a second GPS antenna positioned apart from the first GPS antenna by a predetermined distance (d), and the GPS module is provided to measure north-based azimuth angle (Ψ) and elevation angle (θ) based on the relative positions of the first and second GPS antennas.

### Advantageous Effects

As discussed above, an unmanned aerial vehicle and a self-destruct drone operating system including the same, which are related to at least one example of the present invention, have the following effects.

If a target is designated using an EO camera and/or an IR camera, the target observation-and-location estimation device can estimate the position of the target using a method of measuring azimuth and elevation angles using a moving baseline of a GPS system which measures azimuth and elevation angles, or azimuth and roll angles using two GPS antennas, measuring the distance to the target using a laser range finder (LRF), and then inversely estimating three-dimensional coordinates using the same.

In addition, by rotating the propeller of the rotor in the reverse direction, the unmanned aerial vehicle can overcome gravity, descend vertically to the target at high speeds, and be precisely guided.

Unlike the conventional rotary wing, particularly, the unmanned aerial vehicle reversely converts the rotational direction of the rotor while the aerial vehicle performs vertical descent attacks, thereby generating no vortex ring; it can descend at a very high speed, since it accelerates in the downward direction rather than free fall; and very precise strikes are possible, since it controls the attitude and position using the thrust force in the downward direction.

### DESCRIPTION OF DRAWINGS

FIG. 1 is a perspective diagram of a target observation-and-location estimation device related to one example of the present invention.

FIG. 2 is a perspective diagram showing a state where a target observation-and-location estimation device related to one example of the present invention is provided in a rifle.

FIG. 3 is a conceptual diagram for explaining a measurement method of a target observation-and-location estimation device related to one example of the present invention.

FIG. 4 is a conceptual diagram for explaining one operating state of a self-destruct drone operating system related to one example of the present invention.

FIG. 5 is a flowchart for explaining an operation method of a self-destruct drone operating system related to one example of the present invention.

FIG. 6 is a perspective diagram showing an unmanned aerial vehicle related to one example of the present invention.

FIG. 7 is a conceptual diagram for explaining one operating state of an unmanned aerial vehicle related to one example of the present invention.

FIG. 8 is a perspective diagram showing a rotor of the unmanned aerial vehicle shown in FIG. 6.

FIG. 9 is a side view of the blade shown in FIG. 8.

FIG. 10 is a cross-sectional diagram of a state cut along the line A-A′ shown in FIG. 8.

### MODE FOR INVENTION

Hereinafter, a target observation-and-location estimation device, an unmanned aerial vehicle, and a self-destruct drone operating system including the same, according to an embodiment of the present invention will be described in detail with reference to the accompanying drawings.

In addition, regardless of the reference numerals, the same or corresponding components are assigned the same or similar reference numerals, where duplicate descriptions thereof will be omitted, and for convenience of description, the size and shape of each component shown can be exaggerated or reduced.

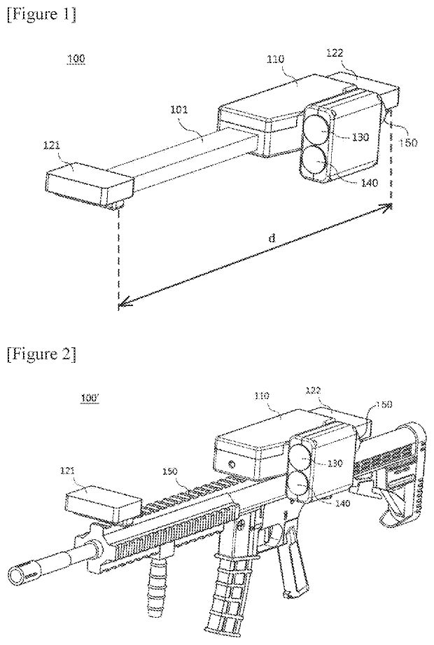

FIG. 1 is a perspective diagram of a target observation-and-location estimation device (100) related to one example of the present invention, and FIG. 2 is a perspective diagram showing a state where a target observation-and-location estimation device (100′) related to one example of the present invention is provided in a rifle.

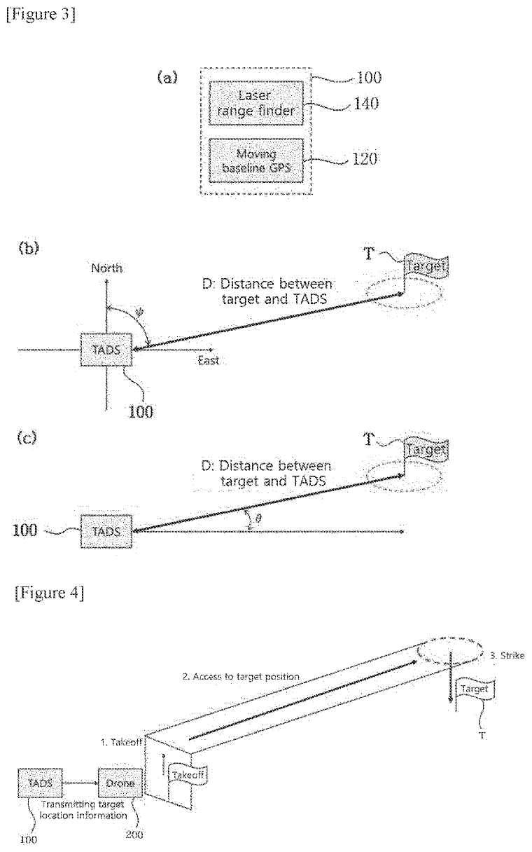

FIG. 3 is a conceptual diagram for explaining a position measurement method of a target observation-and-location estimation device (100) related to one example of the present invention, and FIG. 4 is a conceptual diagram for explaining one operating state of a self-destruct drone operating system related to one example of the present invention.

One example of the present invention comprises a target observation-and-location estimation device (100), and a self-destruct drone operating system including the same.

In the present invention, a target observation-and-location estimation device (hereinafter, also referred to as a ‘TADS’) is provided to measure and calculate location information of the target, and to transmit the location information of the target to an external device. In addition, the external device comprises an unmanned aerial vehicle (hereinafter, also referred to as a ‘drone’).

Furthermore, the self-destruct drone operating system comprises a target observation-and-location estimation device (100), and an unmanned aerial vehicle (200). The range finder (140) comprises a laser range finder.

Referring to FIGS. 1 to 4, the target observation-and-location estimation device (100) related to one example of the present invention comprises a range finder (140), a GPS module (120), an observation control part, and a display part (150).

Specifically, the target observation-and-location estimation device (100) comprises a range finder (140) for measuring the distance (D) to the target (T). In addition, the range finder comprises a laser range finder (140).

Furthermore, the target observation-and-location estimation device (100) comprises a GPS module (120) provided to measure the north-based azimuth angle (Ψ) and elevation angle (θ) of the target. In this document, the GPS module is configured in a way to measure azimuth and elevation angles using a moving baseline, which may be referred to as a moving baseline GPS.

That is, the target observation-and-location estimation device (100) uses a moving baseline method of arranging two GPS antennas apart from each other at a certain distance, and calculating the position and angle of the location estimation device using a difference between two different GPS data.

In addition, the target observation-and-location estimation device (100) comprises an observation control part provided to calculate location information of the target including the latitude, longitude, and altitude of the target (T) based on the north-based azimuth angle (Ψ) and elevation angle (θ) of the target (T) measured in the GPS module (120), and to transmit the distance to the target and the location information of the target to an external device.

Furthermore, the target observation-and-location estimation device (100) may comprise a display part (150) provided to display image information and location information of the target. The display part (150) may be a scope used in general observation equipment.

Meanwhile, the GPS module (120) comprises a first GPS antenna (121) and a second GPS antenna (122) positioned apart from the first GPS antenna (121) by a predetermined distance (d).

The observation control part calculates the latitude, longitude, and altitude of the target (T) in each of the first GPS antenna (121) and the second GPS antenna (122) based on the north-based azimuth angles (Ψ) and elevation angles (θ) of the target (T) measured in the first GPS antenna (121) and the second GPS antenna (122). In addition, the observation control part calculates the location information including the latitude, longitude, and altitude of the target (T) based on the relative positions (e.g., altitude difference) of the first and second GPS antennas (121, 122).

In addition, the GPS module (120) is provided to measure the north-based azimuth angle (Ψ) and elevation angle (θ) of the target based on the relative positions of the first and second GPS antennas (121, 122).

The location information of the target may be calculated through the following general equations 1 to 8.

lat_coefficient=111132.95−559.822×cos(2×lat)+1.175×cos(4×lat) [General Equation 1]

lon_coefficient=111412.88×cos(lat)−93.5×cos(3×lat)+0.12×cos(5×lat) [General Equation 2]

DistN=LRF_dist×cos(pitch)×cos(MBheading) [General Equation 3]

DistE=LRF_dist×cos(pitch)×sin(MBheading) [General Equation 4]

deltaH=LRF_dist×sin(pitch) [General Equation 5]

TargetLat=DistN/lat_coefficient+lat [General Equation 6]

TargetLon=DistE/lon_coefficient+lon [General Equation 7]

TargetAlt=deltaH+height [General Equation 8]

Meanwhile, in the target observation-and-location estimation device (100), the antenna located on the side where the distance to the target (T) is relatively close is the first GPS antenna (121), and the antenna located on the side where the distance to the target (T) is relatively far is the second GPS antenna (121).

In addition, the first GPS antenna (121) and the second GPS antenna (122) may be disposed coaxially with respect to an imaginary axis parallel to the laser irradiation axis of the laser range finder (140).

In General Equations 1 to 8 above, the lat represents the latitude measured in the second GPS antenna (122) in the target observation-and-location estimation device (100) (hereinafter, referred to as a ‘TADS’), and the lon represents the longitude measured in the second GPS antenna (122) of the TADS.

Also, the pitch represents the pitch angle of the TADS (100), and the pitch angle is an elevation angle (θ), which is determined by the altitude difference between the first GPS antenna (121) and the second GPS antenna (122).

In addition, the MBheading is a moving base heading, which represents a north-based azimuth angle (Ψ). As described above, the azimuth angle of the imaginary axis connecting the first GPS antenna (121) and the second GPS antenna (122) is a moving base heading in [General Equation 3] and [General Equation 4], which is determined by the north-based azimuth angle (Ψ).

Furthermore, the lat coefficient represents the distance value (unit: m) per degree of latitude reflecting the curvature of the earth according to the latitude, and the lon coefficient represents the distance value (unit: m) per degree of longitude reflecting the curvature of the earth according to the latitude.

Also, the DistN represents the north-based distance difference (unit: m) between the TADS (100) and the target; the DistE represents the east-based distance difference (unit: m) between the TADS (100) and the target; and the deltaH represents the altitude difference (unit: m) between the TADS (100) and the target.

In addition, the TargetLat represents the latitude (unit: degree) of the target; the TargetLon represents the longitude (unit: degree) of the target; the TargetAlt represents the altitude (unit: m) of the target; and the LRF_dist represents the distance value (unit: m) to the target measured in the laser range finder (140).

Furthermore, the observation control part may be provided to transmit an operation command of an external device upon transmitting the distance (D) to the target (T), and the location information of the target to the external device. In this case, the external device may comprise an unmanned aerial vehicle, and the operation command may comprise a movement command of the unmanned aerial vehicle toward the target based on the transmitted location information.

Also, the target observation-and-location estimation device (100) may further comprise an inertial navigation device (110) for updating location information. The update rate of location information may be increased by a method of combining the position value and speed value information of the target measured using the GPS module (120), and the attitude and speed information of the inertial navigation device (100) using a Kalman filter to derive the position.

In addition, the target observation-and-location estimation device (100) may further comprise one or more of an EO (electronic optical) camera and an IR (infrared ray) camera (130) for selecting a target.

Meanwhile, referring to FIG. 1, the target observation-and-location estimation device (100) may comprise a base part (101) on which the first GPS antenna (121) and the second GPS antenna (122) are mounted apart at a predetermined interval. In addition, the base part (101) may have a shape extending along an imaginary axis parallel to the laser irradiation axis of the laser range finder (140). In this case, the inertial navigation device (110) may be mounted on the base part (101) between the first GPS antenna (121) and the second GPS antenna (122). One or more cameras (130) of an EO camera and an IR camera may be mounted on the inertial navigation device (101).

Also, referring to FIG. 2, according to another example of the present invention, a firearm (150) equipped with a target observation-and-location estimation device (100′) may be included. In this example, the target observation-and-location estimation device (100′) may comprise the first and second GPS antennas (121, 122), the inertial navigation device (110), the EO/IR camera (130), the laser range finder (140), and the display part (150), except for the base part (101) shown in FIG. 1.

A control method of the target observation-and-location estimation device having such a structure is as follows.

Referring to FIG. 3, the control method of the target observation-and-location estimation device related to one example of the present invention comprises steps of: measuring the position of the target with the first GPS antenna (121); measuring the position of the target with the second GPS antenna (122); and calculating location information of the target including the latitude, longitude, and altitude of the target based on the north-based azimuth angle (Ψ) and elevation angle (θ) of the target measured using the respective positions of the first GPS antenna (121) and the second GPS antenna (122), and the distance (D) to the target measured in the range finder.

Also, referring to FIG. 3, the control method of the target observation-and-location estimation device comprises, in the case of referring to FIG. 3(b), steps of measuring the distance (D) to the target using the laser range finder, and measuring the north-based azimuth angle (heading angle, Ψ) between the location estimation device (100) and the target (T) using the moving baseline GPS (120), and in the case of referring to FIG. 3(c), steps of measuring the ground surface-based pitch angle (θ) between the location estimation device (100) and the target (T) using the moving baseline GPS (120), and measuring the latitude, longitude, and altitude of the target (T) using the GPS information of the location estimation device (100), the distance (D), the north-based azimuth angle (heading angle, Ψ), and the ground surface-based pitch angle (θ) (General Equations 1 to 8).

In addition, referring to FIG. 4, the self-destruct drone operating system related to one example of the present invention comprises an unmanned aerial vehicle (200), and a target observation-and-location estimation device (100) provided to provide location information of a target to the unmanned aerial vehicle.

As described through FIGS. 1 and 3, the target observation-and-location estimation device comprises a range finder (140) for measuring a distance (D) to the target, a GPS module (120) provided to measure north-based azimuth angle (Ψ) and elevation angle (θ) of the target (T), a flight control part provided to measure location information of the target including the latitude, longitude, and altitude of the target based on the north-based azimuth angle (Ψ) and elevation angle (θ) of the target measured in the GPS module (120), and to transmit the distance to the target, and the location information of the target to an unmanned aerial vehicle, and a display part (150) provided to display image information and location information of the target.

In addition, the GPS module (120) comprises a first GPS antenna (121), and a second GPS antenna (122) positioned apart from the first GPS antenna (121) by a predetermined distance (d), and the GPS module (120) is provided to measure the north-based azimuth angle (Ψ) and elevation angle (θ) of the target based on the relative positions of the first and second GPS antennas (121, 122).

As described above, the observation control part of the target observation-and-location estimation device (100) is provided to transmit an operation command of the unmanned aerial vehicle upon transmitting the distance (D) to the target (T) and the location information of the target to the unmanned aerial vehicle. The operation command may comprise a movement command of the unmanned aerial vehicle (200) toward the target based on the transmitted location information.

When the operation command is transmitted from the target observation-and-location estimation device (100), the unmanned aerial vehicle performs takeoffs, accesses to the target location, and strikes.

The control method of the self-destruct drone operating system comprises steps of allowing for the unmanned aerial vehicle (100) to take off at a higher altitude than the relative position with the target (T) received from the location estimation device (100) (TADS), approaching the unmanned aerial vehicle (100) to the position of the target received from the TADS (100) while maintaining a certain altitude, and performing its position control while the unmanned aerial vehicle flies toward the target in a reverse propulsion method that if the distance between the target (T) and the unmanned aerial vehicle is within a certain range, its rotor is rotated in the opposite direction.

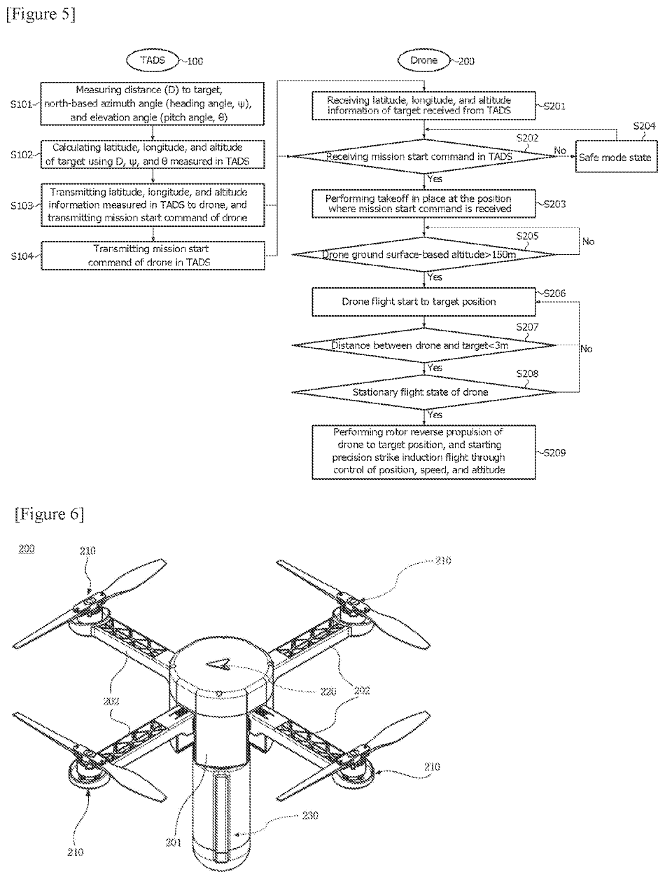

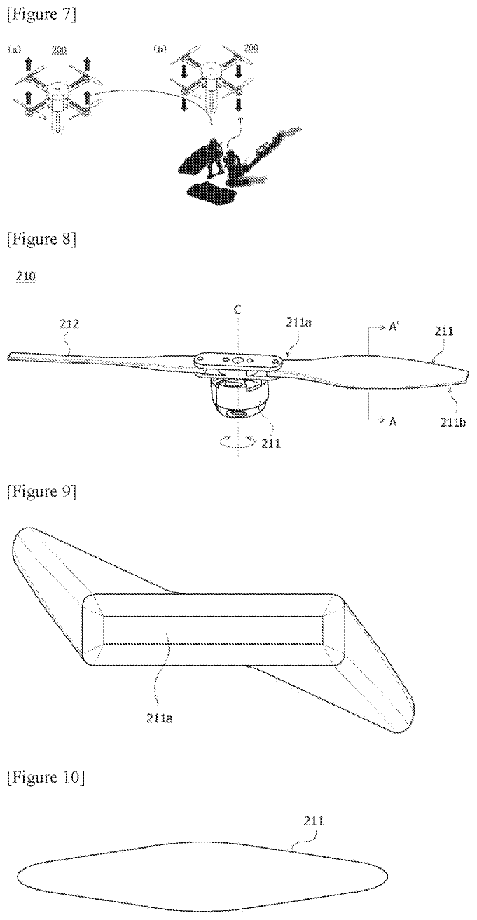

FIG. 5 is a flowchart for explaining an operation method of a self-destruct drone operating system related to one example of the present invention, FIG. 6 is a perspective diagram showing an unmanned aerial vehicle (200) related to one example of the present invention, and FIG. 7 is a conceptual diagram for explaining one operating state of an unmanned aerial vehicle (200) related to one example of the present invention.

FIG. 8 is a perspective diagram showing a rotor (210) of the unmanned aerial vehicle shown in FIG. 6, FIG. 9 is a side view of the blade shown in FIG. 8, and FIG. 10 is a cross-sectional diagram of a state cut along the line A-A′ shown in FIG. 8.

The unmanned aerial vehicle (200) related to one example of the present invention comprises a plurality of rotors (210) capable of rotating in forward and reverse directions, and a flight control part (202) provided to control the rotors (210), and to receive an operation command from an external device (100). In this document, the unmanned aerial vehicle (200) may be operated as a self-destruct drone.

The unmanned aerial vehicle (200) comprises a main body (201), and a plurality of support members (202) each extending along the radial direction of the main body (201) and disposed apart from each other along the circumferential direction of the main body.

The rotor (210) is provided at the end of the support member (202). For example, the number of support members (202) may be the same as the number of rotors (210).

Referring to FIG. 10, each rotor (210) comprises a plurality of blades (211) in which the airfoil has a bilaterally symmetrical shape.

The plurality of rotors (210) may comprise 2 to 8 rotors, and preferably, the plurality of rotors may comprise 3 to 4 rotors.

The rotor (210) may comprise 2 to 4 blades, and preferably, referring to FIG. 8, the rotor may comprise 2 blades (211, 212).

The rotor (210) comprises a body (211) equipped with a driving source for rotating the blades, and the unexplained symbol C denotes a central axis of rotation of the blades (21, 212).

The blade (211) has a fixed end (211a) mounted on the body (211) of the rotor (210), and a free end (211b) in a direction opposite to the fixed end (211a). In this document, the direction from the fixed end (211a) of the blade toward the free end (211b) may be referred to as the longitudinal direction. At this time, in the blade (211), the airfoil of the entire region may have a bilaterally symmetrical shape along the longitudinal direction.

In the case of a general propulsion propeller for drones, the airfoil (blade cross section) is formed to have a bilaterally asymmetrical shape for one-way rotation, that is, the forward direction rotation, and in order to minimize turbulence in the forward direction airflow and to generate no vortex, the entire blade has a shape twisted in the forward direction.

As a result, in the sequence of falling from the target position point, there is a problem that efficiency and stability are lowered because turbulences and vortexes are generated in the operation of rotating the conventional forward direction propeller in the reverse direction to propel the fall acceleration.

In order to solve the above problem, the present invention provides a propeller having a shape capable of producing the same thrust force stability and efficiency even in the rotation situation of the reverse direction as well as the forward direction, that is, a shape in which the airfoil of the blade has a bilaterally symmetrical shape for bidirectional rotation.

In addition, referring to FIG. 8, the blade (211) is designed in a symmetrical structure to ensure optimal thrust force in the bidirectional rotation upon forward and reverse rotation, and designed in the form of a sage leaf, in which the root part of the blade (211) is relatively wide and the tip part is relatively narrow, to prevent air flows from generating vortexes upon rotation.

In this document, referring to FIG. 7(a), when the rotor rotates in the forward direction, the unmanned aerial vehicle (200) may perform operations of taking off and approaching the target (T) position while flying. Alternatively, referring to FIG. 7(b), when the rotor rotates in the reverse direction, the unmanned aerial vehicle (200) may perform operations of descending to the target (T) along the direction of gravitational force and hitting the target (T).

In addition, the unmanned aerial vehicle (200) may comprise one or more bullets (230).

That is, when the location information of the target is received from the external device (target observation-and-location estimation device), the flight control part (220) is provided such that the rotor (210) is rotated in the forward direction to move toward the target (take-off and approach), and upon approaching the received target position, the rotor (210) is rotated in the reverse direction.

Also, the flight control part (220) may control the flight to be made above the target at the received position.

In addition, the flight control part (220) may be provided to rotate the rotor (210) in the reverse direction when the distance to the target is a predetermined distance or less at the received position.

Furthermore, the self-destruct drone operating system related to one example of the present invention comprises the unmanned aerial vehicle (200) explained through FIG. 6, and a target observation-and-location estimation device for transmitting the location information of the target and operation commands to the unmanned aerial vehicle (200).

The target observation-and-location estimation device (100) is as explained through FIG. 1. Specifically, with regard to the target observation-and-estimation device, the target observation-and-location estimation device (100) comprises a range finder (140) for measuring the distance (D) to the target, a GPS module (120) provided to measure north-based azimuth angle (Ψ) and elevation angle (θ) of the target, an observation control part provided to calculate location information including the latitude, longitude, ana altitude of the target based on the north-based azimuth (Ψ) and elevation (θ) of the target measured in the GPS module (120), and to transmit the distance to the target and the location information of the target to an unmanned aerial vehicle, and a display part (150) provided to display image information and location information of the target.

Also, as described above, the GPS module (120) comprises a first GPS antenna (121), and a second GPS antenna (122) positioned apart from the first GPS antenna (121) by a predetermined distance (d). In addition, the GPS module (120) is provided to measure the north-based azimuth (Ψ) and elevation angle (θ) of the target based on the relative positions of the first and second GPS antennas.

Furthermore, the control method of the self-destruct drone operating system is as follows.

The control method comprises steps of: measuring and calculating location information of the target in the location estimation device (100), and transmitting the location information of the target, and operation commands to the unmanned aerial vehicle (100); and performing missions in the unmanned aerial vehicle (100) according to the operation commands.

Specifically, the control method may comprises, in the position estimation device (100), a step of measuring a distance value ( ) to the target, north-based azimuth angle (heading angle, Ψ) and elevation angle (pitch angle, θ) (S101), a step of calculating the latitude, longitude, and altitude of the target using the measured Ψ and θ (S102), a step of transmitting the calculated latitude, longitude, and altitude information to the unmanned aerial vehicle, and transmitting the mission start command of the unmanned aerial vehicle (S103, S104).

Also, the control method comprises, in the unmanned aerial vehicle (200), a step of receiving the latitude, longitude, and altitude information of the target received from the TADS (100) (S201), and a step of receiving the mission start command in the TADS (100) (S202). At this time, in a state where the mission start command is not received, the safe mode state is maintained (S204).

In addition, when the mission start command is received, it comprises a step of performing takeoff in place at the location where the mission start command is received (S203), a step of taking off at a height where the ground surface-based altitude is higher than a predetermined height (e.g., 150 m) (S205), a step of starting a flight to the target location (S206), a step of approaching the distance to the target within a predetermined distance (e.g., 3 m) (S207), a step of checking the stationary flight state of the unmanned aerial vehicle (S208), and a step of performing rotor reverse propulsion of the unmanned aerial vehicle to the target position, and starting a precision strike induction flight through the control of the position, speed, and attitude (S209).

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes and additions are intended to fall within the scope of the following claims.

### INDUSTRIAL APPLICABILITY

As discussed above, an unmanned aerial vehicle and a self-destruct drone operating system including the same, which are related to at least one example of the present invention, have the following effects.

By rotating the propeller of the rotor in the reverse direction, the unmanned aerial vehicle can overcome gravity, descend vertically to the target at high speeds, and be precisely guided.

In addition, unlike the conventional rotary wing, particularly, the unmanned aerial vehicle reversely converts the rotational direction of the rotor while the aerial vehicle performs vertical descent attacks, thereby generating no vortex ring; it can descend at a very high speed, since it accelerates in the downward direction rather than free fall; and very precise strikes are possible, since it controls the attitude and position using the thrust force in the downward direction.

1. An unmanned aerial vehicle, comprising:
a plurality of rotors capable of rotating in forward and reverse directions; and
a flight control part provided to control the rotors, and to receive an operation command from an external device, wherein
each rotor comprises a plurality of blades, the airfoil of which has a bilaterally symmetrical shape.

2. The unmanned aerial vehicle according to claim 1, wherein
the plurality of rotors comprises 2 to 8 rotors.

3. The unmanned aerial vehicle according to claim 1, wherein
the rotor comprises 2 to 4 blades.

4. The unmanned aerial vehicle according to claim 1, wherein
in the blade, the airfoil of the entire region has a bilaterally symmetrical shape along the longitudinal direction.

5. The unmanned aerial vehicle according to claim 1, wherein
the flight control part is provided such that if location information of a target is received from the external device, the rotor is rotated in a forward direction to move toward the target, and upon approaching the received position, the rotor is rotated in a reverse direction.

6. The unmanned aerial vehicle according to claim 5, wherein
the flight control part controls the flight to be made above the target at the received position.

7. The unmanned aerial vehicle according to claim 5, wherein
the flight control part is provided to rotate the rotor in the reverse direction when the distance to the target is a predetermined distance or less at the received position.

8. The unmanned aerial vehicle according to claim 1,
further comprising one or more bullets.

9. A self-destruct drone operating system, comprising:
the unmanned aerial vehicle according to claim 1; and
a target observation-and-location estimation device for transmitting location information of a target and operation commands to the unmanned aerial vehicle, wherein
the target observation-and-location estimation device comprises a range finder for measuring the distance (D) to the target, a GPS module provided to measure the north-based azimuth angle (Ψ) and elevation angle (θ) of the target, an observation control part provided to calculate location information of the target including the latitude, longitude and altitude of the target, based on the north-based azimuth angle (Ψ) and elevation angle (θ) of the target measured in the GPS module, and to transmit the distance to the target and the location information to the unmanned aerial vehicle, and a display part provided to display image information and location information of the target.

10. The self-destruct drone operating system according to claim 9, wherein
the GPS module comprises a first GPS antenna, and a second GPS antenna positioned apart from the first GPS antenna by a predetermined distance (d), and
the GPS module is provided to measure the north-based azimuth (Ψ) and elevation (θ) of the target based on the relative positions of the first and second GPS antennas.
